(19) United States
(12) Patent Application Publication
(10) Pub. No.: US 2009/0212072 A1
(43) Pub. Date: Aug. 27, 2009

(54) Liquid dispenser

(76) Inventor: John C. Fenton, Ashbum, VA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/320,984

(22) Filed: Feb. 10, 2009

Related U.S. Application Data
(60) Provisional application No. 61/064,267, filed on Feb. 25, 2008.

(51) Int. Cl. B67D 5/42

(52) U.S. Cl. 222/173

(57) ABSTRACT

The liquid dispenser has a base having an attachment for an inverted liquid container at one end and a dispenser pump at the other end. The base may be weighted for stability. A supply line extends through the base from the container attachment to the pump, and a vent line extends from the pump area back to the container attachment. The inverted container allows a viscous liquid, e.g., soap, lotion, or perhaps ketchup or other sauces in a restaurant environment, to drain from the container without waste or extraordinary efforts to access the last few measures of liquid from the container. When the container is to be replaced, the assembly is inverted, the old container is removed, and a new container or the original refilled container is reinstalled. The assembly is then returned to its upright position for continued use.

### CROSS-REFERENCE TO RELATED APPLICATION

This application claims the benefit of U.S. Provisional Patent Application Ser. No. 61/064,267, filed Feb. 25, 2008.

### BACKGROUND OF THE INVENTION

1. Field of the Invention

The present invention relates generally to dispensing devices. More specifically, the present invention is a liquid dispenser for dispensing lotions, liquid soaps, and similar liquids.

2. Description of the Related Art

Dispensers for liquids, such as hand lotions, liquid soaps, etc., have been known for a considerable time. Examples of such devices are commonly seen in public restrooms as wall-mounted dispensers, and various countertop or sink-top mounted dispensers are also known. In addition to such permanently mounted dispensers, a number of freestanding, portable dispensers have been developed as well. In many cases, manufacturers have provided an inexpensive hand pump in combination with the cap of the container, allowing the container with its cap-mounted pump to be used as the dispenser.

Such portable freestanding units, as well as countertop- or sink top-mounted units, have the container positioned upright, with the container opening or outlet at the top of the container. This makes it quite difficult to drain the last several applications of the liquid lotion, soap, etc. from the container, due to the viscous nature of such liquids. In the case of freestanding units, the consumer will often remove the liquid pump and invert and shake the container in an attempt to get the last of the material out of the container.

Depending upon the configuration of the container cap, it may be possible to leave the container in an inverted position for some time to allow the liquid to drain into the neck of the container. However, this often results in a mess when the cap is removed and considerably more liquid has drained into the neck of the container than is desired for the single application or use. It can be difficult to balance a container in an inverted position as well.

Many, if not most, wall-mounted liquid dispensers have an inverted permanent container that must be refilled from time to time from another supply container. This can be difficult as well, as the dispenser container must be removed from its inverted installation for refilling. The potential for spillage is obvious, unless the dispenser container has been completely emptied before refilling.

Another environment where complete usage of a viscous liquid in a container is economically important is in the restaurant industry, where ketchup, various sauces, etc. are generally provided in rigid or flexible squeeze bottles or containers for customer use. It is a common sight in many such establishments to see a nearly empty, inverted ketchup bottle perched precariously atop another bottle in an attempt to drain the last of the material from the inverted bottle. The alternative would be to lose perhaps several ounces per day of material from the nearly depleted containers. While this may not seem to be critical, it can add up to several dollars per week for a restaurant or similar business.

Thus, a liquid dispenser solving the aforementioned problems is desired.

### SUMMARY OF THE INVENTION

The liquid dispenser has a portable base having a container attachment fitting at one end and a hand-actuated dispenser pump at the other end. The base may be weighted for additional stability, and the container attachment fitting may be elevated above the base of the pump for better drainage. A liquid supply line extends through the base from the attachment fitting to the dispenser pump, with an air return or vent line extending from the area of the pump back into the container attachment fitting. The vent line may include an anti-backflow valve or device therewith. A conventional container of lotion, liquid soap, or other liquid is mounted atop the container attachment fitting, with its inverted orientation allowing complete drainage of the liquid contained therein. An adapter may be provided for different sizes or configurations of container attachments, and a decorative cover may be provided for the container.

The user of the device manipulates the hand pump in the conventional manner to dispense the lotion, soap, or other liquid contained within the device. When the container has been completely emptied it may be removed from its attachment fitting, the dispenser base inverted, a new container attached to the fitting or the old container refilled and reattached, and the assembly returned to its normal upright position with the container inverted upon its attachment fitting.

These and other features of the present invention will become readily apparent upon further review of the following specification and drawings.

### BRIEF DESCRIPTION OF THE DRAWINGS

FIG. 1 is an environmental, perspective view of a liquid dispenser according to the present invention, showing its general features and use.

FIG. 2 is an exploded perspective view of the liquid dispenser, illustrating alternative features thereof.

FIG. 3 is a front elevation view in section of the liquid dispenser, illustrating various internal features thereof.

Similar reference characters denote corresponding features consistently throughout the attached drawings.

### DETAILED DESCRIPTION OF THE PREFERRED EMBODIMENTS

The present invention relates to a liquid dispenser having a freestanding base, i.e., a portable dispenser, with a container attachment fitting and separate manual dispensing pump extending upwardly therefrom. The container of liquid (soap, lotion, or perhaps ketchup or sauce in a restaurant or kitchen environment) is inverted when attached to the container attachment fitting, thereby allowing essentially all of the liquid or viscous fluid to drain from the container without the consumer having to resort to extraordinary effort to recover the last remains of the liquid or fluid from the container.

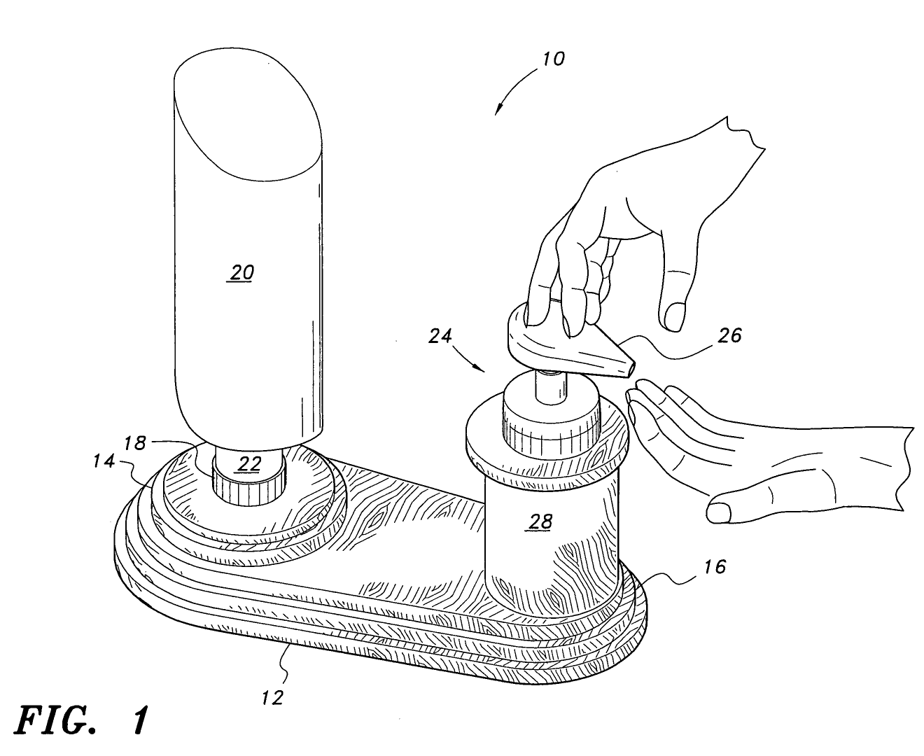

FIG. 1 provides a general environmental perspective view of the dispenser 10, showing its general features and operation. A freestanding, portable base 12 is provided to support and house the other components of the device. The base 12 may have an elongate shape, as shown, or any other desired shape. The base 12 includes a container support portion 14 and an opposite dispenser pump portion 16 separated from the container support portion. An attachment fitting 18, e.g., an internally threaded cap or the like, is permanently and immovably affixed to the container support portion 14 of the base 12 and extends upwardly therefrom, thus allowing a liquid container 20 (e.g., hand lotion or soap for bathroom or restroom use, or perhaps ketchup or other sauce for restaurant or kitchen use, etc.) to be removably installed thereon.

The container 20 is inverted when installed upon the base 12 with the base resting atop another surface (countertop, etc.) in its normal position for use, with the neck 22 of the container 20 being disposed at the bottom of the container and secured within the attachment fitting 18.

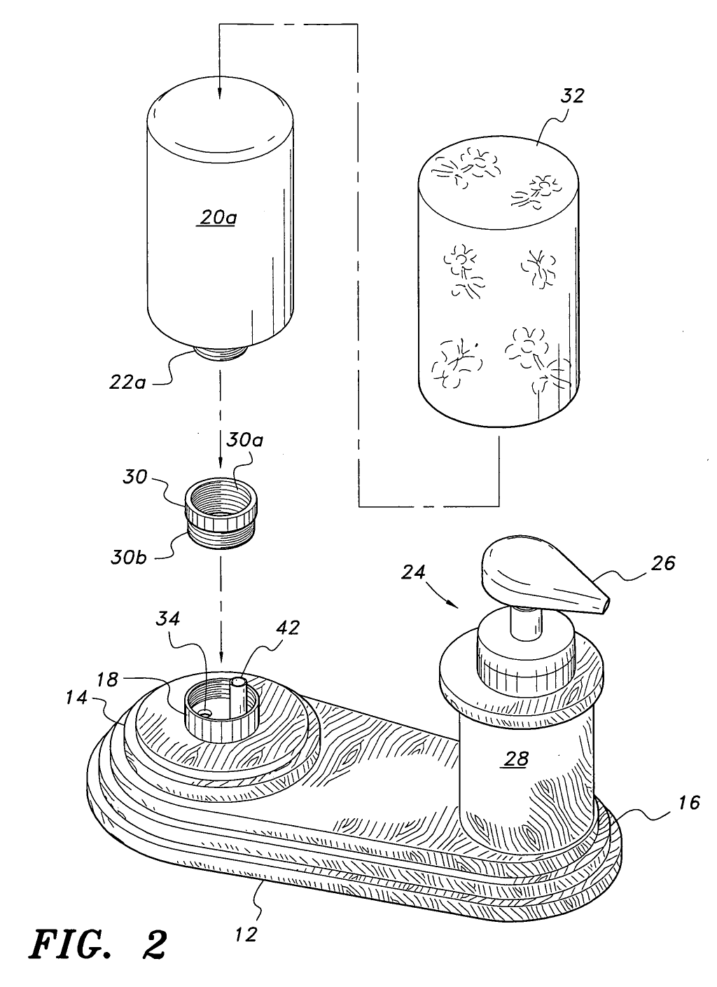

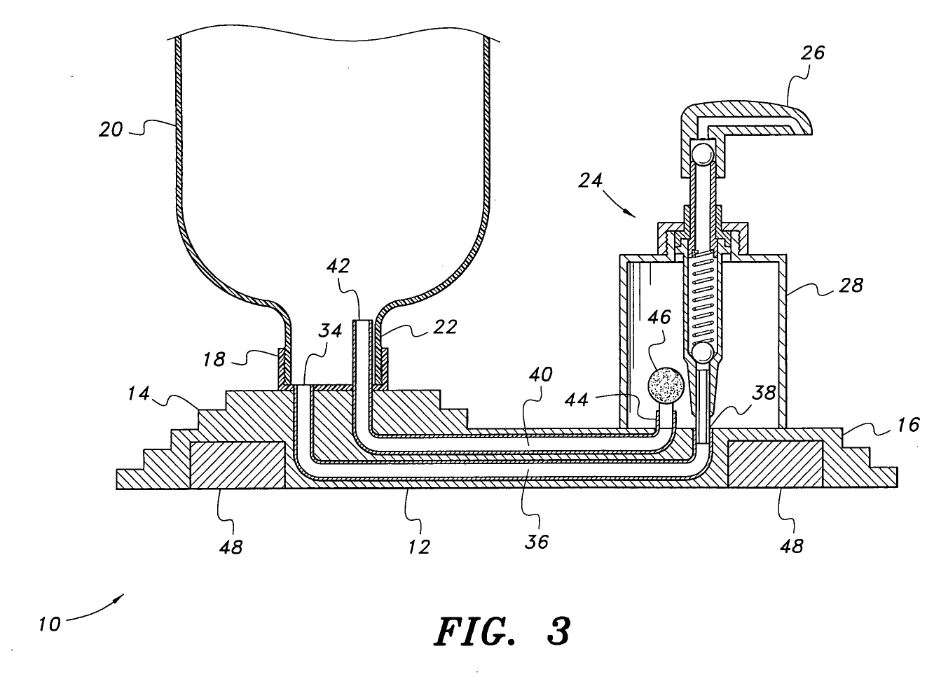

The opposite dispenser pump portion 16 includes a manually actuated dispenser pump 24 extending upwardly therefrom. Hand pressure on the pump, generally as shown in FIG. 1, causes liquid to be dispensed from the pump nozzle 26. The pump 24 may include a cover or housing 28 disposed thereover and therearound to support the pump 24 above the base 12. The cover or housing 28 may comprise a cylindrical wall with a separate flanged top of wood or similar material, as shown in FIGS. 1 and 2, or the cylindrical wall and top may be formed as an integral unit, as shown in FIG. 3. It will be understood that, while a reciprocating manually actuated pump 24 is shown throughout the drawings, other types of manually actuated pumps may be used.

FIG. 2 provides an exploded perspective view of the dispenser 10, and illustrates some alternative components and additional features. The various containers that might be used with the present dispenser 10 may have different sizes, with the container necks varying in size correspondingly. FIG. 2 illustrates a somewhat smaller container 20a than shown in FIGS. 1 and 3, with the smaller container 20a having a correspondingly smaller neck 22a. An adapter 30 is provided to accommodate the smaller neck 22a of the container 20a, with the standard container attachment fitting 18 extending upwardly from the base 12. The adapter 30 has a relatively smaller diameter internally threaded portion 30a that removably attaches to and mates with the smaller neck 22a of the smaller container 20a, and a standard diameter externally threaded portion 30b that removably installs in and mates with the internal threads of the container attachment fitting 18. While threaded attachment fittings are shown in the drawings, it should be noted that other attachment means may be provided, depending upon the configuration of the neck of the container 20, 20a, etc. to be used with the dispenser 10.

In certain cases the exterior of the container 20, 20a, etc. may not present a pleasing appearance to users of the dispenser 10. Accordingly, a decorative cover 32 may be provided for the container, as shown in FIG. 2. Various covers 32 may be provided, sized to removably fit over correspondingly dimensioned containers, or a single larger cover may be provided to fit any practicable container 20, 20a, etc. that might be used with the liquid dispenser 10. In the case of multiple covers, such covers may have different decorative designs or patterns thereon, allowing the user to change covers in keeping with the seasons or other themes or decorative concepts.

FIG. 3 provides an elevation view in section of the dispenser 10, showing various structural details thereof. In FIG. 2, a hole or passage 34 may be seen through the interior of the container attachment fitting 18 and ending flush with the interior of the fitting 18. This passage 34 is the inlet end of the supply line 36 that extends from the attachment fitting 18 through the base 12 to the inlet end 38 of the dispenser pump 24, as shown in FIG. 3. Liquid or fluid flows from the container 20 through the supply line 36 to the dispenser pump 24 for dispensing by conventional reciprocating operation of the pump. It will be noted at this point that the container support portion 14 of the base 12 is at least slightly elevated above the dispenser pump portion 16 of the base, particularly above the inlet end 38 of the pump 24. This is illustrated most clearly in FIG. 3. This provides a slightly better pressure head for the liquid relative to the pump 24, thereby providing better drainage of the liquid (particularly viscous liquids) from the container 20.

A vent line 40 extends through the base 12 back to an outlet end 42 disposed above the inner base of the container attachment fitting 18 to permit airflow into the container. The opposite inlet end 44 of the vent line may be placed adjacent the dispenser pump 24 within the pump cover or housing 28, with the pump,cover or housing 28 not providing an airtight fit between the pump 24 and base 12. The inlet end 44 of the vent line 40 includes some form of anti-backflow device 46 therewith, e.g., a porous ceramic air stone of the type sold as an aeration device for home aquariums and the like. The air stone allows air to flow therethrough and back through the vent line 40 to the container 20 to replenish lost air as liquid is pumped from the container, but the fine porosity of the air stone does not allow the viscous fluid within the container to flow back through the vent line 40 and out the inlet end 44 of the vent line 40. Alternatively, a ball check valve or a flapper valve may be used to prevent backflow of air through the vent line 40.

While the vent line 40 is shown above the supply line 36 in FIG. 3, this is primarily for clarity in the drawing. The vent line 40 and supply line 36 may be installed to lie horizontally adjacent to one another, or the vent line 40 may extend to an air inlet at some other part of the base 12. Also, the base 12 preferably includes one or more weights 48 installed therein to provide additional stability for the assembly and counteract the relatively high mass of the bottle or container 20 when it is full or nearly so.

In conclusion, the liquid dispenser in its various embodiments provides a notable improvement in the efficiency of such devices by allowing the entire contents of a bottle or container attached thereto to be completely emptied from the container and used as desired. The liquid dispenser is particularly useful in the home environment for use in dispensing hand lotions and the like in the bathroom, but is also useful for dispensing liquid soaps, hand cleansers for use in the shop or garage, etc. The use of the device may also be extended to the dispensing of various comestibles, such as ketchup, mustard, barbecue and other sauces, etc., in the kitchen or restaurant environment, with much the same improvements in efficiency in completely draining or emptying all of the product from the container attached thereto.

It is to be understood that the present invention is not limited to the embodiments described above, but encompasses any and all embodiments within the scope of the following claims.

I claim:

1. A liquid dispenser, comprising:
a freestanding base having a container support portion and a dispenser pump portion opposite the container support portion;
a liquid container attachment fitting extending upwardly from the container support portion of the base;
a dispenser pump extending upwardly from the dispenser pump portion of the base; and
a supply line extending through the base from the container attachment fitting to the dispenser pump.

2. The liquid dispenser according to claim 1, further including a vent line extending through the base to the container attachment fitting.

3. The liquid dispenser according to claim 2, wherein the vent line further includes an anti-backflow device.

4. The liquid dispenser according to claim 1, wherein the container support portion is elevated relative to the dispenser pump portion of the base.

5. The liquid dispenser according to claim 1, further including at least one weight disposed within the base.

6. The liquid dispenser according to claim 1, further including an adapter removably disposed within the container attachment fitting.

7. The liquid dispenser according to claim 1, further including:
a liquid container removably disposed upon the container attachment fitting; and
a cover removably disposed over the container.

8. A liquid dispenser, comprising:
a freestanding base having a container support portion and a dispenser pump portion opposite the container support portion;
a liquid container attachment fitting extending upwardly from the container support portion of the base;
a dispenser pump extending upwardly from the dispenser pump portion of the base;
a supply line extending through the base from the attachment fitting to the dispenser pump; and
a vent line extending through the base to the container attachment fitting.

9. The liquid dispenser according to claim 8, wherein the vent line further includes an anti-backflow device.

10. The liquid dispenser according to claim 8, wherein the container support portion is elevated relative to the dispenser pump portion of the base.

11. The liquid dispenser according to claim 8, further including at least one weight disposed within the base.

12. The liquid dispenser according to claim 8, further including an adapter removably disposed within the container attachment fitting.

13. The liquid dispenser according to claim 8, further including:
a liquid container removably disposed upon the container attachment fitting; and
a cover removably disposed over the container.

14. A liquid dispenser, comprising:
a freestanding base having a container support portion and a dispenser pump portion opposite the container support portion, the container support portion being elevated relative to the dispenser pump portion;
a liquid container attachment fitting extending upwardly from the container support portion of the base;
a dispenser pump extending upwardly from the dispenser pump portion of the base; and
a supply line extending through the base from the attachment fitting to the dispenser pump.

15. The liquid dispenser according to claim 14, further including a vent line extending through the base to the container attachment fitting.

16. The liquid dispenser according to claim 15, wherein the vent line further includes an anti-backflow device.

17. The liquid dispenser according to claim 14, further including at least one weight disposed within the base.

18. The liquid dispenser according to claim 14, further including an adapter removably disposed within the container attachment fitting.

19. The liquid dispenser according to claim 14, further including:
a liquid container removably disposed upon the container attachment fitting; and
a cover removably disposed over the container.
